(19) United States
(12) Patent Application Publication
(10) Pub. No.: US 2013/0164651 A1
(43) Pub. Date: Jun. 27, 2013

(54) SOLID OXIDE FUEL CELL AND CURRENT COLLECTING METHOD THEREOF

(71) Applicants: Jong Ho Chung, Gyunggi-do (KR); Jai Hyoung Gil, Seoul (KR); Kyong Bok Min, Gyunggi-do (KR); Jong Sik Yoon, Seoul (KR); Eon Soo Lee, Gyeongsangbuk-do (KR)

(72) Inventors: Jong Ho Chung, Gyunggi-do (KR); Jai Hyoung Gil, Seoul (KR); Kyong Bok Min, Gyunggi-do (KR); Jong Sik Yoon, Seoul (KR); Eon Soo Lee, Gyeongsangbuk-do (KR)

(73) Assignee: SAMSUNG ELECTRO-MECHANICS CO., LTD., Gyunggi-do (KR)

(21) Appl. No.: 13/432,100

(22) Filed: Mar. 28, 2012

(30) Foreign Application Priority Data
Dec. 22, 2011 (KR) 1020110139904

(51) Int. Cl. H01M 8/10; H01M 8/00; H01M 2/20; H01M 8/02

(52) U.S. Cl. 429/482; 429/535

(57) ABSTRACT

Disclosed herein is a solid oxide fuel cell including a cylindrical fuel cell and a current collector inserted with the cylindrical fuel cell and herein, the current collector is constituted by the semicircular mesh structure inserted with the cylindrical fuel cell and at least one metal connection plate connected with both ends of an opened part of the mesh structure and having an inner surface contacting a lower part of the mesh structure. According to the present invention, serial and parallel connections between cells of the fuel cell can be arbitrarily constructed with a metal connection plate and a current collector having a mesh structure as one unit module.

### CROSS REFERENCE TO RELATED APPLICATION

This application claims the benefit of Korean Patent Application No. 10-2011-0139904, filed on Dec. 22, 2011, entitled “Solid Oxide Fuel Cell and Current Collecting Method Thereof”, which is hereby incorporated by reference in its entirety into this application.

### BACKGROUND OF THE INVENTION

1. Technical Field

The present invention relates to a solid oxide fuel cell and a current collecting method thereof.

2. Description of the Related Art

A renewable energy problem is a big issue nationally and socially, and as a result, since a fuel cell as one among renewable energy can generate energy such as electricity from an alternative energy source such as hydrogen as well as petroleum, LNG, and LPG fuels, the fuel cell has been in the spotlight.

Among various types of the fuel cells that directly convert chemical energy of the fuel into electric energy by an electrochemical reaction, a research for commercialization of a solid oxide fuel cell (SOFC) which is advantageous in terms of high theoretical efficiency and being capable of using various fuels without a reformer for home or power generation are actively being conducted primarily by gas companies and electric power companies. However, since the SOFC operates at high temperature of approximately 800° C., the SOFC has a problem regarding development of an appropriate material having durability even in terms of costs such as low-priced materials or structures as well as a problem regarding a structure capable of stably output high power and technological objects such as management of heat and water, power conversion, control, system operation, and the like.

The SOFC adopts an oxygen ion conductor conducting only oxygen ions, unlike an existing polymer electrolyte membrane fuel cell adopting a hydrogen ion conductor. In the SOFC, a fuel including carbon or hydrogen flows to one side and air flows to the other side around an oxygen ion electrolyte as a separating membrane and in this case, oxygen in the air moves to a negative electrode through the electrolyte membrane and reacts with the fuel to generate carbon dioxide or water. The SOFC generates electricity while directly converting chemical reaction energy generated during the oxidation of the fuel into electric energy.

A feature of the SOFC is in that any fuel of a carbon or hydro-carbon based fuel can be used unlike the existing polymer electrolyte membrane fuel cell (PEMFC), the degree of freedom of fuel selection is high and a chemical reaction formula when hydrogen (H₂) is used as the fuel is described below.

Anode reaction: H₂(g)+O²⁻→H₂O(g)+2e⁻CO(g)+O²⁻→CO₂(g)+2e⁻

Cathode reaction: O₂(g)+4e⁻→2O²⁻

Overall reaction: O₂+H²+CO→H₂O+CO₂

An existing current collecting method by intercell connection or an external electrode of a cylindrical fuel cell representatively includes a wire winding method of collecting current by winding an outer part of an electrode with a high-conductive wire and connecting cells with each other by extending a current collecting wire and a method of collecting current by using a foam structure.

For example, Korean Patent Laid-Open Publication No. 2011-0085848 discloses a method of winding an outer part of an electrode for collecting current. In the case of this method, the length of a wire collecting current increases according to the size of a cell, causing increasing resistance, and as a result, performance of the cell is deteriorated due to an increase in current collecting resistance, thereby deteriorating performance of an overall system.

Further, Korean Patent Laid-Open Publication No. 2003-0066042 discloses a method of collecting current by using a metallic foam structure. This method is simpler in collecting current and more structurally stable in stack integration than a structure in which the cell is only inserted between foams. However, since the foams need to be plated with silver (Ag), the unit cost of the foam is also high and a silver plating cost is also much.

### SUMMARY OF THE INVENTION

The present invention has been made in an effort to provide a solid oxide fuel cell that can arbitrarily construct serial and parallel connections between cells of the fuel cell with a metal connection plate and a current collector having a mesh structure as one unit module.

Further, the present invention has been made in an effort to provide a method for collecting current of the solid oxide fuel cell that can perform current collection of the fuel cell economically in terms of material and process costs due to a material and a structure which are simple.

According to a preferred embodiment of the present invention, there is provided a solid oxide fuel cell including: a cylindrical fuel cell including a cylindrical anode, an electrolyte membrane formed on an outer peripheral surface of the cylindrical anode, a cathode formed on an outer peripheral surface of the electrolyte membrane, and a connector formed in a lengthwise strip pattern at one side of the outer peripheral surface of the cylindrical anode to protrude outside the outer peripheral surface of the cathode and spaced apart from the cathode; and a current collector including a semicircular mesh structure, and the current collector is constituted by the semicircular mesh structure inserted with the cylindrical fuel cell and at least one metal connection plate connected with both ends of an opened part of the mesh structure and having an inner surface contacting a lower part of the mesh structure.

The connector may be constituted by a protection layer formed in a part from which a part of the electrolyte membrane is removed and a conductive layer formed by applying a conductive material onto the protection layer.

The protection layer may be made of steel use stainless.

The mesh structure may be made of conductive meshes or metal with pores.

The number of the conductive meshes may be 10 to 80.

The conductive mesh or the metal may be selected from a group consisting of iron, copper, aluminum, nickel, chrome, an alloy thereof.

The mesh structure may be anti-oxidation coated.

The metal connection plate may be made of a material selected from a group consisting of iron, copper, aluminum, nickel, chrome, or an alloy thereof.

The metal connection plate may be anti-oxidation coated.

According to another preferred embodiment of the present invention, there is provided a current collecting method of a solid oxide fuel cell including: providing a cylindrical fuel cell including a cylindrical anode, an electrolyte membrane formed on an outer peripheral surface of the cylindrical anode, a cathode formed on an outer peripheral surface of the electrolyte membrane, and a connector formed in a lengthwise strip pattern at one side of the outer peripheral surface of the cylindrical anode to protrude outside the outer peripheral surface of the cathode and spaced apart from the cathode; and providing a current collector constituted by the semicircular mesh structure and at least one metal connection plate connected with both ends of an opened part of the mesh structure and having an inner surface contacting a lower part of the mesh structure; inserting the cylindrical fuel cell into the semicircular mesh structure; and arranging the current collectors inserted with the cylindrical fuel cells and electrically connecting the cylindrical fuel cells with each other.

The arrangement may be serial, parallel, or serial and parallel.

The connector may be constituted by a protection layer formed in a part from which a part of the electrolyte membrane is removed and a conductive layer formed by applying a conductive material onto the protection layer.

The protection layer may be made of steel use stainless.

The mesh structure may be made of conductive meshes or metal with pores.

The number of the conductive meshes may be 10 to 80.

The conductive mesh or the metal may be selected from a group consisting of iron, copper, aluminum, nickel, chrome, an alloy thereof.

The mesh structure may be anti-oxidation coated.

The metal connection plate may be made of a material selected from a group consisting of iron, copper, aluminum, nickel, chrome, or an alloy thereof.

The metal connection plate may be anti-oxidation coated.

### BRIEF DESCRIPTION OF THE DRAWINGS

FIG. 1 is a cross-sectional view of a cell of a cylindrical fuel cell according to a preferred embodiment of the present invention;

FIG. 2 is a cross-sectional view of a current collector inserted with the cell of the cylindrical fuel cell according to the preferred embodiment of the present invention;

FIG. 3 is a photograph of the current collector according to the preferred embodiment of the present invention; and

FIG. 4 is a cross-sectional view of a cylindrical fuel cell stack for current collection of the cylindrical fuel cell according to the preferred embodiment of the present invention.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

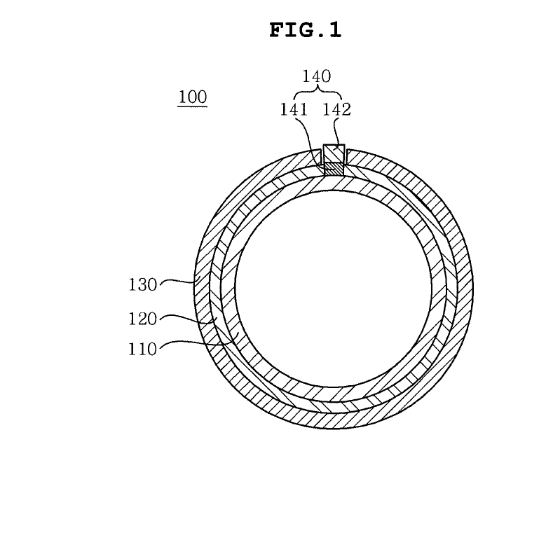

FIG. 1 is a cross-sectional view of a cell of a cylindrical fuel cell according to a preferred embodiment of the present invention. As shown in FIG. 1, the cylindrical fuel cell 100 according to the preferred embodiment of the present invention includes a cylindrical anode 110 an electrolyte membrane 120, a cathode 130, and a connector 140. More specifically, the cylindrical fuel cell 100 includes the cylindrical anode 110, the electrolyte membrane 120 formed on an outer peripheral surface of the cylindrical anode, the cathode 130 formed on an outer peripheral surface of the electrolyte membrane, and the connector 140 formed in a lengthwise strip pattern at one side of the outer peripheral surface of the cylindrical anode to protrude outside the outer peripheral surface of the cathode and spaced apart from the cathode.

The cylindrical anode 110 serves to support the fuel cell 100 and may be formed by heating NiO-YSZ (Yttria stabilized Zirconia) at 1200 to 1300° C. The electrolyte membrane 120 may be formed by coating an outer part of the anode 110 with Yttria stabilized Zirconia (YSZ) or Scandium stabilized Zirconia (ScSZ), GDC, LDC, or the like by using a slip coating or plasma spray coating method and thereafter, sintering the coated anode at 1300 to 1500° C. The cathode 130 may be formed by coating the outer peripheral surface of the electrolyte membrane 120 with compositions such as strontium doped Lanthanum manganite (LSM), (La,Sr)(Co,Fe)O₃ (LSCF), and the like by using the slip coating or plasma spray coating method and thereafter, sintering the coated outer peripheral surface of the electrolyte membrane 120 at 1200 to 1300° C.

The connector 140 is formed after stacking the anode 110, the electrolyte membrane 120, and the cathode 130 in sequence and serves to transfer current generated from the anode 110 to the current collector 200 in contact with a mesh structure 210 of a current collector 200 to be described below.

Further, the connector 140 protrudes toward the outer part of the anode 110 from one side of the outer peripheral surface of the anode 110 to contact a metal connection plate 220 of the current collector. In addition, the connector 140 may be spaced apart from the cathode 130 by a predetermined gap or an insulating layer (not shown) may be formed between the cathode 130 and the connector 140 in order to prevent a short circuit from the cathode 130 and the connector 140 preferably protrudes upward by considering a contact with the metal connection plate 220 of the current collector to be described below. Herein, the connector may include a protection layer 141 for preventing reaction gas of a hydrogen fuel from leaking to a part from which the electrolyte is removed by removing a part of the electrolyte membrane 120 and lifting a dense membrane such as steel use stainless (SUS) in the part from which the electrolyte is removed. A conductive layer 142 is formed on the protection layer. A material having high conductivity, particular, a conductive ceramic material is applied to the conductive layer to reduce current collection loss. For example, the conductive ceramic material is preferably one type or more selected from (La,Sr)MnO₃(LSM), (La,Ca)CrO₃(LCC), (La,Sr)FeO₃(LSF), (La,Sr)CoO₃(LSCo), (La,Sr)CrO₃(LSC), (La,Sr)(Co,Fe)O₃(LSCF), and (Sm,Sr)CoO₃(SSC), (Ba,Sr)(Co,Fe)O₃(BSCF) or mixtures thereof.

Herein, a current collector inserted with the fuel cell to form one unit module will be described.

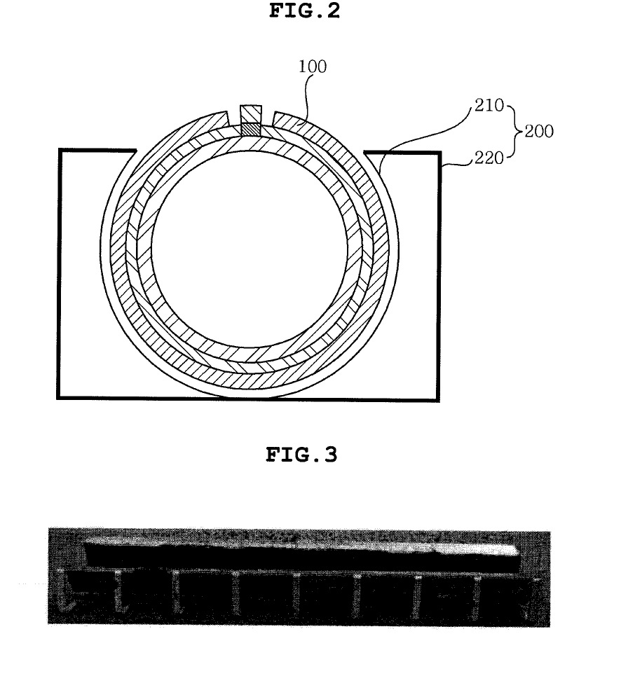

FIGS. 2 and 3 are a cross-sectional view and a photograph of the current collector according to the preferred embodiment of the present invention, respectively. As shown in FIG. 2, the current collector 200 includes a semi-circular mesh structure 210 and at least one metal connection plate 220 connected with both ends of the mesh structure and having an inner surface selectively contacting a lower part of the mesh structure.

In the preferred embodiment of the present invention, current collectors each constituted by the mesh structure manufactured by conductive meshes or metal with pores by replacing an existing method of collecting current of the anode or cathode by winding an existing silver wire around the electrode or attaching nickel (Ni) felt/mesh to the outer part of the fuel cell and forming stacks by connecting respective fuel cells as are used unit modules and the current collectors are arbitrarily connected to each other in parallel and in series to facilitate current collection and intercell connection. In this case, the number of the used conductive meshes is preferably 10 to 80 by considering supplying of air and current collection efficiency and air is supplied up to the surface of the fuel cell 100 through the pores provided on the meshes. Further, the conductive mesh or the metal with pores is rolled up in the shape of the fuel cell 100 to be processed in a semicircular shape so as to expose a part corresponding to the connector 140 to form the mesh structure 210 and the fuel cell 100 is inserted into the current collector 200 constituted by the processed mesh structure 210 and the metal connection plate 220 connected thereto to form the unit modules and thereafter, the unit modules are arranged in series and in parallel to collect current outside the cell.

Referring to FIGS. 2 and 3, the metal connection plate 220 is connected to both ends of the mesh structure 210 and is positioned with an inner surface thereof contacting the lower part of the mesh structure. Herein, the metal connection plate may be one or more and has a rectangular shape in which an upper part is opened. Both ends thereof are connected to both ends of the semicircular mesh structure to serve as a connecting and supporting body of the mesh structure. The metal connection plate is selected from a group consisting of iron, copper, aluminum, nickel, chrome, and an alloy and a combination thereof and is preferably anti-oxidation coated with silver (Ag) or conductive ceramics (MnCo, NiCl, LSC, and LSCF) in order to maintain durability at high temperature.

Further, air should be transferred to the cathode 130 in order to generate current and the current collector 200 according to the preferred embodiment of the present invention receives air from the mesh structure 210 made of the conductive meshes or the metal with pores and transfers the received air to the cathode 130. Therefore, the mesh structure 210 is preferably made of the conductive meshes or the metal with pores, which is easily connected with the fuel cell with gas permeability. In this case, the number of the conductive meshes is preferably 10 to 80 by considering air supplying and current collection efficiency and the metal with the pores includes metal foam, a plate, or a metal fiber and more preferably, the conductive meshes and metal are selected from a ground constituted by iron, copper, aluminum, nickel, chrome, an alloy thereof and a combination thereof by considering efficiency, required rigidity, and the like of the fuel cell and anti-oxidation coated with silver (Ag) or conductive ceramics (MnCo, NiCl, LSC, and LSCF) in order to maintain durability at high temperature.

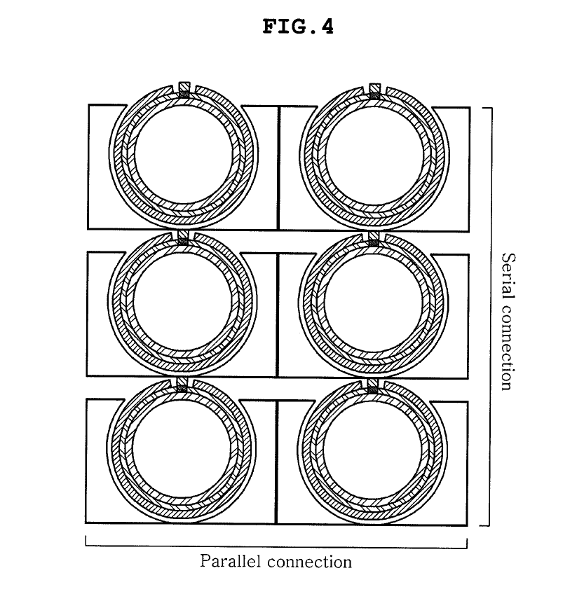

Referring to FIG. 4, when the fuel cell is inserted into the current collector 200 having the shape to form the unit module, the unit modules are arranged in parallel so that side surfaces of the respective metal connection plates contact each other or stacks having serial/parallel connections among the fuel cells 100 are formed by contacting the connector 140 and the metal connection plate 220 through stacking the unit modules, high-priced precious metals are wound and cells collecting current by winding the high-priced precious metals are connected to each other one by one to replace existing complicated type of internal stack connection forming serial and parallel connections for each unit cell in the existing method.

Meanwhile, a current collecting method of the solid oxide fuel cell according to a preferred embodiment of the present invention includes forming unit modules by inserting a cylindrical fuel cell into a mesh structure of a current collector and thereafter, electrically connecting the unit modules formed as above.

Specifically, there is provided the cylindrical fuel cell 100 including a cylindrical anode, an electrolyte membrane formed on an outer peripheral surface of the cylindrical anode, a cathode formed on an outer peripheral surface of the electrolyte membrane, and a connector formed in a lengthwise strip pattern at one side of the outer peripheral surface of the cylindrical anode to protrude outside the outer peripheral surface of the cathode and spaced apart from the cathode and there is provided at least one metal connection plate 220 connected with both ends of a semicircular mesh structure 210 and having an inner surface selectively contacting a lower part of the mesh structure to form a current collector 200 and thereafter, the fuel cell 100 is inserted into the semicircular mesh structure to form the unit modules.

Herein, the unit modules may be arranged in parallel so that side surfaces of the respective metal connection plates contact each other or stacks having serial/parallel connections among the fuel cells 100 may be manufactured by contacting the connector 140 and the metal connection plate 220 by stacking the unit modules, and as a result, current collection of the fuel cell can be performed more economically by arbitrarily constructing the serial and parallel connections among the fuel cells.

As set forth above, according to preferred embodiments of the present invention, serial and parallel connections between cells of the fuel cell can be arbitrarily constructed with a metal connection plate and a current collector having a mesh structure as one unit module. Further, current collection of the fuel cell can be performed economically in terms of material and process costs due to a material and a structure which are simple.

Although the preferred embodiments of the present invention have been disclosed for illustrative purposes, they are for specifically explaining the present invention and thus a solid oxide fuel cell and a current collecting method thereof according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A solid oxide fuel cell, comprising:
a cylindrical fuel cell including a cylindrical anode, an electrolyte membrane formed on an outer peripheral surface of the cylindrical anode, a cathode formed on an outer peripheral surface of the electrolyte membrane, and a connector formed in a lengthwise strip pattern at one side of the outer peripheral surface of the cylindrical anode to protrude outside the outer peripheral surface of the cathode and spaced apart from the cathode; and
a current collector including a semicircular mesh structure,
wherein the current collector is constituted by the semicircular mesh structure inserted with the cylindrical fuel cell and at least one metal connection plate connected with both ends of an opened part of the mesh structure and having an inner surface contacting a lower part of the mesh structure.

2. The solid oxide fuel cell as set forth in claim 1, wherein the connector is constituted by a protection layer formed in a part from which a part of the electrolyte membrane is removed and a conductive layer formed by applying a conductive material onto the protection layer.

3. The solid oxide fuel cell as set forth in claim 2, wherein the protection layer is made of steel use stainless.

4. The solid oxide fuel cell as set forth in claim 1, wherein the mesh structure is made of conductive meshes or metal with pores.

5. The solid oxide fuel cell as set forth in claim 4, wherein the number of conductive meshes is 10 to 80.

6. The solid oxide fuel cell as set forth in claim 4, wherein the conductive mesh or the metal is selected from a group consisting of iron, copper, aluminum, nickel, chrome, an alloy thereof.

7. The solid oxide fuel cell as set forth in claim 1, wherein the mesh structure is anti-oxidation coated.

8. The solid oxide fuel cell as set forth in claim 1, wherein the metal connection plate is made of a material selected from a group consisting of iron, copper, aluminum, nickel, chrome, or an alloy thereof.

9. The solid oxide fuel cell as set forth in claim 1, wherein the metal connection plate is anti-oxidation coated.

10. A current collecting method of a solid oxide fuel cell, comprising:
providing a cylindrical fuel cell including a cylindrical anode, an electrolyte membrane formed on an outer peripheral surface of the cylindrical anode, a cathode formed on an outer peripheral surface of the electrolyte membrane, and a connector formed in a lengthwise strip pattern at one side of the outer peripheral surface of the cylindrical anode to protrude outside the outer peripheral surface of the cathode and spaced apart from the cathode; and;
providing a current collector constituted by the semicircular mesh structure and at least one metal connection plate connected with both ends of an opened part of the semicircular mesh structure and having an inner surface selectively contacting a lower part of the mesh structure;
inserting the cylindrical fuel cell into the semicircular mesh structure; and
arranging the current collectors inserted with cylindrical the fuel cells and electrically connecting the cylindrical fuel cells with each other.

11. The current collecting method of a solid oxide fuel cell as set forth in claim 10, wherein the arrangement is serial, parallel, or serial and parallel.

12. The current collecting method of a solid oxide fuel cell as set forth in claim 10, wherein the connector is constituted by a protection layer formed in a part from which a part of the electrolyte membrane is removed and a conductive layer formed by applying a conductive material onto the protection layer.

13. The current collecting method of a solid oxide fuel cell as set forth in claim 12, wherein the protection layer is made of steel use stainless.

14. The current collecting method of a solid oxide fuel cell as set forth in claim 10, wherein the mesh structure is made of conductive meshes or metal with pores.

15. The current collecting method of a solid oxide fuel cell as set forth in claim 14, wherein the number of the conductive meshes is 10 to 80.

16. The current collecting method of a solid oxide fuel cell as set forth in claim 14, wherein the conductive mesh or the metal is selected from a group consisting of iron, copper, aluminum, nickel, chrome, an alloy thereof.

17. The current collecting method of a solid oxide fuel cell as set forth in claim 10, wherein the mesh structure is anti-oxidation coated.

18. The current collecting method of a solid oxide fuel cell as set forth in claim 10, wherein the metal connection plate is made of a material selected from a group consisting of iron, copper, aluminum, nickel, chrome, or an alloy thereof.

19. The current collecting method of a solid oxide fuel cell as set forth in claim 10, wherein the metal connection plate is anti-oxidation coated.
